(19) United States
(12) Patent Application Publication
(10) Pub. No.: US 2007/0225964 A1
(43) Pub. Date: Sep. 27, 2007

(54) APPARATUS AND METHOD FOR IMAGE RECOGNITION AND TRANSLATION

(75) Inventors: Chiung-Hsien Wu, Taipei (TW); Ming-Lun Lee, Taipei (TW); Pin-Chuan Wang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: INVENTEC APPLIANCES CORP., Taipei (TW)

(21) Appl. No.: 11/668,474

(22) Filed: Jan. 30, 2007

(30) Foreign Application Priority Data
Mar. 27, 2006 (TW) 95110498

(51) Int. Cl. G06F 17/28

(52) U.S. Cl. 704/2

(57) ABSTRACT

An apparatus and a method for image recognition and translation are disclosed. In the present invention, an image is captured by an image capturing unit and the words in the image are recognized by a character recognizing module. Next, the recognized words are then translated into a designated language by a translating module. Finally, the translated words are displayed in a display unit. Therefore, the present invention not only avoids the problem that users cannot look up words of which they don't understand the language, but also provides users with a convenient way to input words, such that the purposes of instant use and fast translation are achieved.

### CROSS-REFERENCE TO RELATED APPLICATION

This application claims the priority benefit of Taiwan application serial no. 95110498, filed Mar. 27, 2006. All disclosure of the Taiwan application is incorporated herein by reference.

### BACKGROUND OF THE INVENTION

1. Field of the Invention

The present invention relates to an apparatus for image recognition and translation. More particularly, the present invention relates to an apparatus for translating words read on an object into a designated language.

2. Description of Related Art

Previous translators all operate by keying in the words intended to be looked up in an input key manner by users, searching for the corresponding translations in a built-in database thereof, and then displaying the querying results on the screen to be viewed by the users. Along with the rapid development of electronic technology, consumer electronic products available in the market are, without exception, integrated with a variety of functions to enhance the competitiveness thereof. Besides general functions such as photographing, calling, and surfing the net, nowadays even the translation function can be integrated into a portable electronic apparatus such as a cellular phone or a personal digital assistant (PDA). The manner in which a conventional translator inputs words has developed from key input into such manners as handwriting and voice input, thus provides the users with not only a convenient way to input words quickly but also diversified choices.

However, the character-by-character (or letter-by-letter) keying input manner or the handwriting input manner are rather time-consuming and are unable to meet the needs at emergency time. Additionally, under the current trend of a light, thin, short, and small electronic product, the installation of a keyboard on an electronic product may result in inconvenience in use as the keys are too small, and if changed into a larger keyboard or handwriting pad, the volume of the electronic product is increased, thus decreasing the portability and competitiveness of the product.

Additionally, the looking-up function of a conventional translator is based on the premise that users understand the letters or pronunciation of the words which are read, and must be in accompany with applicable input methods or microphones to smoothly input and seek the translation results. However, when a user is on a business trip or on a tour abroad, it is likely that the user may be unable to look up the words of which the user doesn't even understand the letters, which is rather inconvenient.

### SUMMARY OF THE INVENTION

In this regard, the present invention is directed to provide an apparatus for image recognition and translation, which captures an image by an image capturing apparatus such as a camera, translates the words in the image with a built-in character recognizing module and a translating module, and then displays the translation result on a screen.

The present invention is further directed to provide a method for image recognition and translation, which provides the users with a way to understand the content of the words in an image by capturing the image intended to be translated or the words that are read, recognizing the words in the image, and correspondingly translating the words into a proper language.

As embodied and broadly described herein, the present invention provides an apparatus for image recognition and translation, which comprises an image capturing unit, a character recognizing module, a translating module, and a display unit. The image capturing unit is suitable for capturing an image comprising at least one word belonging to a first language. The character recognizing module is suitable for recognizing the words in the image. Moreover, the translating module is suitable for translating the words into a second language, and the display unit is suitable for displaying the words that are translated into the second language.

The present invention provides a method for image recognition and translation applicable to a portable electronic apparatus. The method comprises: first, capturing an image comprising at least one word belonging to a first language; next, recognizing the words in the image; then, translating the recognized words into a second language; and finally, displaying the words that are translated into the second language.

As the present invention adopts a structure consisting of an image capturing unit, a character recognizing, and a translating module, when users intend the words to be translated, they only need to capture an image comprising the words, and then the words are recognized and translated into a designated language, thus facilitating the users to understand the content of the words.

In order to make the aforementioned and other objectives, features, and advantages of the present invention comprehensible, preferred embodiments accompanied with figures are described in detail below.

### BRIEF DESCRIPTION OF THE DRAWINGS

FIG. 1 is a block diagram of an apparatus for image recognition and translation according to a preferred embodiment of the present invention; and

FIG. 2 is a flow chart of a method for image recognition and translation according to a preferred embodiment of the present invention.

### DESCRIPTION OF EMBODIMENTS

In order to make the content of the present invention more apparent, embodiments are described below as examples according to which the present invention can indeed be implemented.

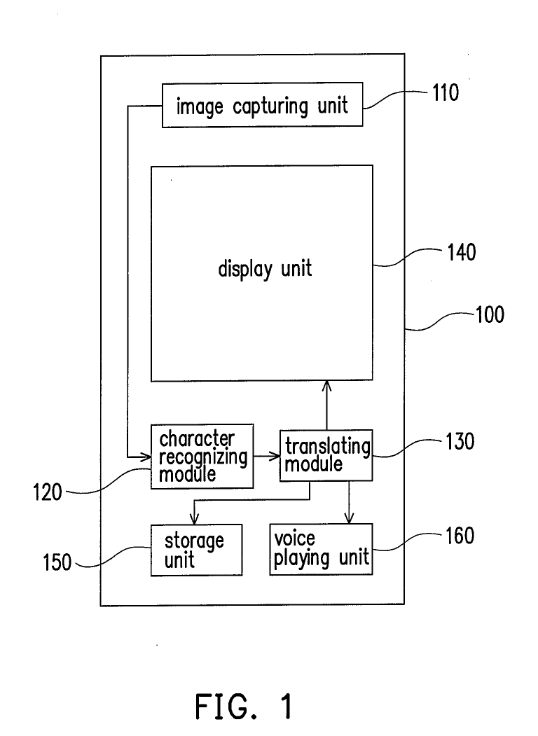

FIG. 1 is a block diagram of an apparatus for image recognition and translation according to a preferred embodiment of the present invention. Referring to FIG. 1, the apparatus for image recognition and translation 100 of this embodiment is, for example, a cellular phone, a PDA, a smart phone, or a translator, which includes an image capturing unit 110, a character recognizing module 120, a translating module 130, a display unit 140, a storage unit 150, a voice playing unit 160, and is able to provide users with instant translation of the words in an image.

The image capturing unit 110 is suitable for capturing an image. The character recognizing module 120 is suitable for recognizing the words in the captured image. The words can be composed of characters (for such as Chinese words) and letters (for such as English words). Next, the translating module 130 translates the recognized words into a designated language. Finally, the display unit 140 displays the translated words. Additionally, the storage unit 150 is used to record the translated words for being read by the users at any time. The voice playing unit 160 informs the users of the translated words in a voice playing manner.

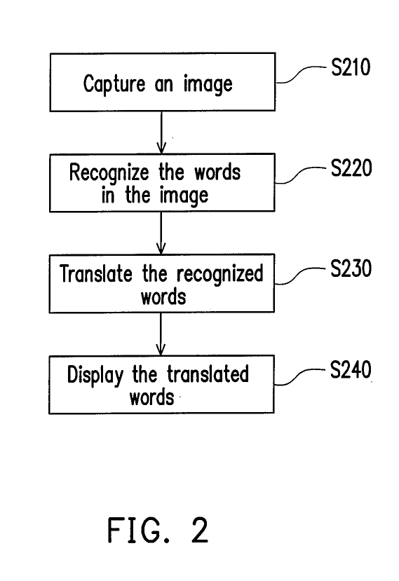

FIG. 2 is a flow chart of a method for image recognition and translation according to a preferred embodiment of the present invention. Referring to FIGS. 1 and 2 simultaneously, this embodiment introduces in detail how the words on an object are translated into a designated language through the apparatus for image recognition and translation 100 of the present invention.

First, on seeing an image or words intended to be translated, for example, a poster, a bulletin board, or a menu of a restaurant, the user can first capture an image of the object by the image capturing unit 110 (Step S210). The image includes at least one word belonging to a first language (for example, English). In this step, the image capturing unit 110 is, for example, a charge-coupled device (CCD) camera, or a complementary metal oxide semiconductor (CMOS) camera but is not limited herein.

After the capturing step is completed, the built-in character recognizing module 120 in the apparatus for image recognition and translation 100 starts to recognize the words in the image (Step S220). In this step, the user can select a range of the image on demands. The character recognizing module 120 is then able to recognize only the characters of the words within this range, thus reducing the time for character recognizing and increasing the correctness of character recognition.

Next, the built-in translating module 130 in the apparatus for image recognition and translation 100 translates the words recognized by the character recognizing module 120 into a designated second language (for example, Chinese) (Step S230). In this step, the user can select or set the language to be translated into in the apparatus for image recognition and translation 100. Such language may include languages of various countries such as Chinese, English, French, Spanish, depending on the type and quantity of languages the translating module 130 supports, which is not limited herein.

After the translating step is completed, the translated words are displayed on the display unit 140 of the apparatus for image recognition and translation 100 (Step S240). In this step, the display unit 140 may be a liquid crystal display (LCD) screen, and the display manner thereof may be to purely display words or simultaneously to display the image and the at least one word that is translated into the second language, which is not limited herein.

Additionally, in another preferred embodiment of the present invention, the translated words can be played in a voice playing manner, so as to provide the users with a way to understand the pronunciation of the words or to communicate with others. Moreover, the translated words can be stored for future use of study or reference, which is rather convenient.

In view of the above, the apparatus and method for image recognition and translation of the present invention at least have the following advantages:

1. Supporting languages of various countries so as to avoid the problem that users cannot key in or read out words for translations thereof because they don't understand the language to which the words belong.

2. With the capturing function of a camera, the purposes of instant use and fast translation are easily achieved and the time for users to input words to be translated is reduced.

3. Without the need of keyboard input, the volume of the apparatus can hence be reduced, thus providing users with convenience in portability.

4. Integrated into the existing cellular phones, PDAs, without additionally increasing the production cost of the apparatus.

Though the present invention has been disclosed above by the preferred embodiments, they are not intended to limit the present invention. Anybody skilled in the art can make some modifications and variations without departing from the spirit and scope of the present invention. Therefore, the protecting range of the present invention falls in the appended claims.

What is claimed is:

1. An apparatus for image recognition and translation, comprising:
an image capturing unit for capturing an image, wherein the image comprises at least one word belonging to a first language;
a character recognizing module for recognizing the at least one word in the image;
a translating module for translating the recognized at least one word into a second language; and
a display unit for displaying the translated at least one word into the second language.

2. The apparatus for image recognition and translation as claimed in claim 1, further comprising:
a voice playing unit for voice playing the at least one word that is translated into the second language.

3. The apparatus for image recognition and translation as claimed in claim 1, further comprising:
a storage unit for storing the at least one word that is translated into the second language.

4. The apparatus for image recognition and translation as claimed in claim 1, wherein the apparatus for image recognition and translation is a cellular phone, a personal digital assistant (PDA), a smart phone, or a translator.

5. The apparatus for image recognition and translation as claimed in claim 1, wherein the image capturing unit is a charge-coupled device (CCD) camera or a complementary metal oxide semiconductor (CMOS) camera.

6. The apparatus for image recognition and translation as claimed in claim 1, wherein the display unit is a liquid crystal display (LCD) screen.

7. The apparatus for image recognition and translation as claimed in claim 1, wherein the manner in which the display unit displays the at least one word that is translated into the second language is to purely display the word(s).

8. The apparatus for image recognition and translation as claimed in claim 1, wherein the manner in which the display unit displays the at least one word that is translated into the second language is simultaneously to display the image and the at least one word that is translated into the second language.

9. A method for image recognition and translation in a portable electronic apparatus, the method comprising:
capturing an image comprising at least one word belonging to a first language;
recognizing the at least one word in the image;
translating the recognized at least one word into a second language; and
displaying the at least one word that is translated into the second language.

10. The method for image recognition and translation as claimed in claim 9, further comprising:
playing the at least one word that is translated into the second language.

11. The method for image recognition and translation as claimed in claim 9, further comprising:
storing the at least one word that is translated into the second language.

12. The method for image recognition and translation as claimed in claim 9, wherein the step of recognizing the at least one word belonging to the first language comprises:
selecting at least one word intended to be translated from the image; and
recognizing the selected at least one word.

13. The apparatus for image recognition and translation as claimed in claim 9, wherein the portable electronic apparatus is a cellular phone, a PDA, a smart phone, or a translator.
